(19) United States
(12) Patent Application Publication
(10) Pub. No.: US 2015/0127706 A1
(43) Pub. Date: May 7, 2015

(54) Systems and Methods for Data Extraction

(71) Applicant: Tencent Technology (Shenzhen) Company Limited, Shenzhen (CN)

(72) Inventors: Cheng Li, Shenzhen (CN); Hui Zheng, Shenzhen (CN); Zhenyu Yang, Shenzhen (CN); Xiangyong Wang, Shenzhen (CN)

(21) Appl. No.: 14/591,259

(22) Filed: Jan. 7, 2015

Related U.S. Application Data
(63) Continuation of application No. PCT/CN2014/079976, filed on Jun. 16, 2014.

(30) Foreign Application Priority Data
Jul. 9, 2013 (CN) 201310286905.5

(51) Int. Cl. H04L 29/08

(52) U.S. Cl. CPC H04L 67/10; H04L 67/142
USPC 709/201

(57) ABSTRACT

Systems and methods are provided for data extraction based on model-view-controller (MVC). For example, a data extraction request of a control layer object is acquired; network address parameters and a data carrier object corresponding to the data extraction request are acquired; a network data capturing function of the data carrier object is called based on at least information associated with the network address parameters to capture network data; the captured network data is analyzed based on at least information associated with the data carrier object; value assignment is performed on the data carrier object based on at least information associated with the analysis of the network data; and the data carrier object is returned to the control layer object corresponding to the data extraction request.

### CROSS-REFERENCES TO RELATED APPLICATIONS

The application claims priority to Chinese Patent Application No. 201310286905.5, filed Jul. 9, 2013, incorporated by reference herein for all purposes.

### BACKGROUND OF THE INVENTION

Certain embodiments of the present invention are directed to computer technology. More particularly, some embodiments of the invention provide systems and methods for data processing. Merely by way of example, some embodiments of the invention have been applied to data extraction. But it would be recognized that the invention has a much broader range of applicability.

In a conventional Model-View-Controller (MVC) design paradigm, a data stream is usually controlled by a control layer object. The control layer object often extracts data from a model layer object and sends it to a view layer object for display. In addition, the control layer object can receive input data acquired by the view layer object and store the input data into a model layer object. Furthermore, the control layer object usually needs to capture network data according to service requirements, and then the captured network data is encapsulated into a data carrier object on a control layer. The data carrier object is sent to a view layer for display, and the data carrier object is stored into a model layer.

The above-noted conventional technology has some disadvantages. For example, the network data often needs to be captured by the control layer and then the network data is encapsulated according to the data carrier object defined by the model layer. The degree of coupling between the control layer and the model layer is increased. When class attributes of the data carrier object need to be modified, the codes related to the control layer may need to be correspondingly modified, so that the scalability is reduced.

Hence it is highly desirable to improve the techniques for data extraction.

### BRIEF SUMMARY OF THE INVENTION

According to one embodiment, a method is provided for data extraction based on model-view-controller (MVC). For example, a data extraction request of a control layer object is acquired; network address parameters and a data carrier object corresponding to the data extraction request are acquired; a network data capturing function of the data carrier object is called based on at least information associated with the network address parameters to capture network data; the captured network data is analyzed based on at least information associated with the data carrier object; value assignment is performed on the data carrier object based on at least information associated with the analysis of the network data; and the data carrier object is returned to the control layer object corresponding to the data extraction request.

According to another embodiment, a device is provided for data extraction based on model-view-controller (MVC). The device includes a request acquisition module configured to acquire a data extraction request of a control layer object; a data carrier object acquisition module configured to acquire network address parameters and a data carrier object corresponding to the data extraction request; a data capturing module configured to call a network data capturing function of the data carrier object based on at least information associated with the network address parameters to capture the network data; a data encapsulation module configured to analyze the captured network data based on at least information associated with the data carrier object and carry out value assignment on the data carrier object based on at least information associated with the data obtained by analysis; and a data return module configured to return the data carrier object to the control layer object corresponding to the data extraction request.

According to yet another embodiment, a non-transitory computer readable storage medium includes programming instructions for data extraction based on model-view-controller (MVC). The programming instructions are configured to cause one or more data processors to execute certain operations. For example, a data extraction request of a control layer object is acquired; network address parameters and a data carrier object corresponding to the data extraction request are acquired; a network data capturing function of the data carrier object is called based on at least information associated with the network address parameters to capture network data; the captured network data is analyzed based on at least information associated with the data carrier object; value assignment is performed on the data carrier object based on at least information associated with the analysis of the network data; and the data carrier object is returned to the control layer object corresponding to the data extraction request.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a framework related to model-view-controller (MVC) according to one embodiment of the present invention.

FIG. 2 is a simplified diagram showing a method for data extraction based on model-view-controller (MVC) according to one embodiment of the present invention.

FIG. 3 is a simplified diagram showing a data extraction device based on model-view-controller (MVC) according to one embodiment of the present invention.

FIG. 4 is a simplified diagram showing a data extraction device based on model-view-controller (MVC) according to another embodiment of the present invention.

### DETAILED DESCRIPTION OF THE INVENTION

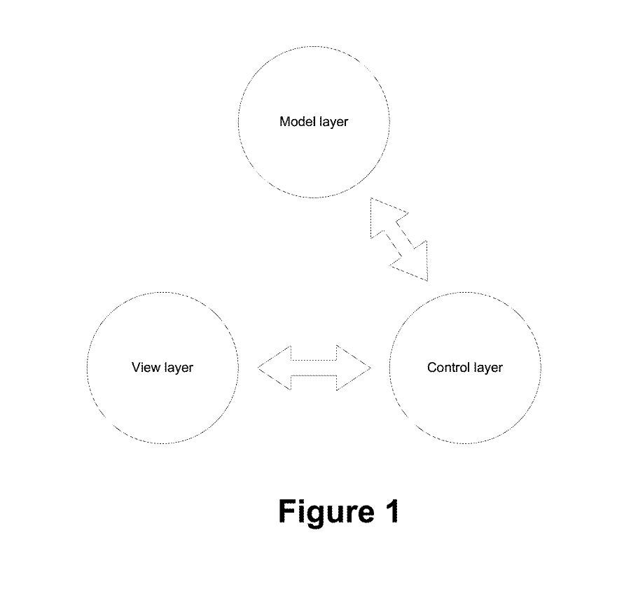

FIG. 1 is a simplified diagram showing a framework related to model-view-controller (MVC) according to one embodiment of the present invention. The diagram is merely an example, which should not unduly limit the scope of the claims. One of ordinary skill in the art would recognize many variations, alternatives, and modifications.

According to one embodiment, MVC stands for Model-View-Controller, and corresponds to a software design paradigm. For example, MVC is configured to organize codes using a software framework that separates service logics and data display. As an example, with MVC, service logics are aggregated into a component and interactions between an interface and a user related to data can be modified and customized in a personalizing manner without rewriting the service logics. In another example, the MVC is uniquely developed for mapping functions of input, process and output into a logic graphic user interface structure.

As shown in FIG. 1, a view layer object is configured to define a display mode and a style of data, according to certain embodiments. For example, a model layer object is configured for persistent storage of the data. As an example, a control layer object is configured to extract the data from the model layer object according to a preset reading service logic and send the data to the view layer object for expression. In another example, the control layer object is further configured to screen or encapsulate the data input by the user via the view layer object according to a preset writing service logic and then transfer the data to the model layer object for persistent storage. The view layer object, the control layer object, and the model layer object have independent functions and the degree of coupling between different layers is lower, so that the scalability becomes higher, in some embodiments.

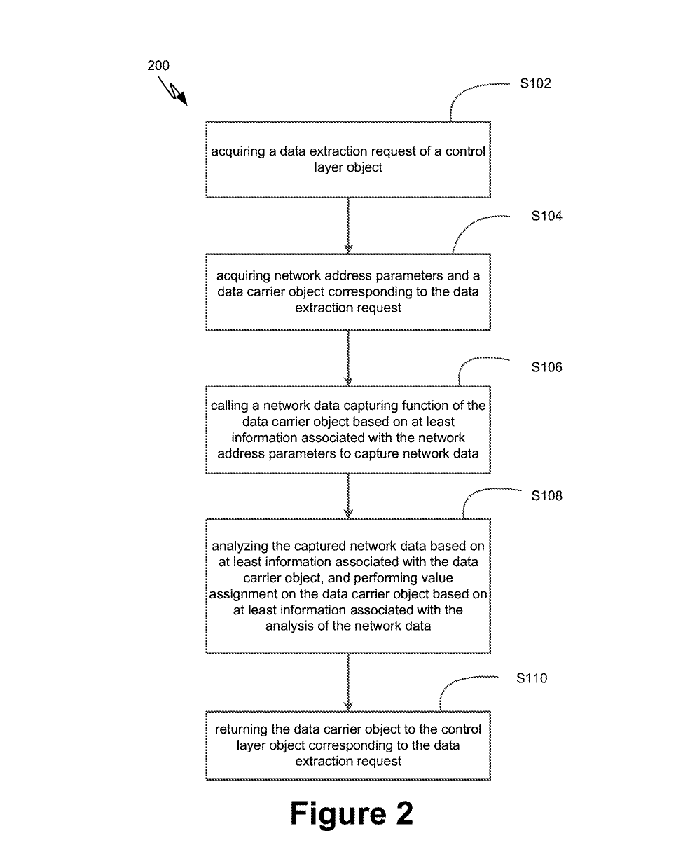

FIG. 2 is a simplified diagram showing a method for data extraction based on model-view-controller (MVC) according to one embodiment of the present invention. The diagram is merely an example, which should not unduly limit the scope of the claims. One of ordinary skill in the art would recognize many variations, alternatives, and modifications. The method 200 includes at least processes of S102-S110.

According to one embodiment, the method 200 that is based on a MVC framework depends on a computer program executed on a computer system on the basis of the Von Neumann architecture. For example, during the process S102, a data extraction request of the control layer object is acquired. As an example, during the process S104, network address parameters and data carrier object corresponding to the data extraction request are acquired. In another example, the data extraction request is initiated by the control layer object and is accepted by the model layer object. If the service logic in the control layer object needs to capture external network data over the network, corresponding network address parameters can be added into the data extraction request, in some embodiments. For example, the data carrier object caches the data by class attributes and is used for a data object transmitted between software modules. As an example, if a model layer uses a database storage mode as a persistent storage mode, the data carrier object includes a value object (VO). The user table in a database can correspond to a user VO and each field in the user table corresponds to each class attribute item of the user VO. For example, a name field and an age field in the user table in the database can correspond to a name attribute and an age attribute in the user VO.

According to another embodiment, a data carrier type identification corresponding to the data extraction request can be acquired according to data mapping configuration of the MVC framework. For example, the user VO corresponds to a control layer object related to a user service logic in the data mapping configuration of the MVC framework. In another example, a microblog VO corresponds to a control layer object related to a microblog service logic in the data mapping configuration of the MVC framework. The data extraction request sent out by the control layer object is related to the user service logic corresponds to the user VO, according to certain embodiments.

According to yet another embodiment, if the data extraction request does not include the network address parameters (e.g., the network address parameters are not acquired), persistent data corresponding to the data extraction request is acquired and the data carrier object corresponding to the data extraction request is generated according to the persistent data and is returned. For example, a determination can be made according to the condition whether the data extraction request includes the network address parameters. If the data extraction request includes the network address parameters, it indicates that data which a service layer object is to acquire can be obtained through network capturing according to the network address parameters. If the data extraction request does not include the network address parameters, it indicates that the data which the service layer object is to acquire corresponds to data of persistent storage by the model layer.

In one embodiment, if the model layer uses the database storage mode as the persistent storage mode, keywords corresponding to the data extraction request can be extracted, and then persistent data corresponding to the keywords is searched for in the database. As an example, the corresponding data carrier object is generated according to the data carrier type identification and is returned.

In another embodiment, when the data extraction request only includes keyword “ZhangSan” of a user name, a user table in the database can be acquired, and a data item corresponding to the keyword “ZhangSan” is searched for in the user table. For example, the user VO is generated according to the data item. In another example, the name attribute of the user VO is “ZhangSan” and other class attributes correspond to values in other fields in the data item.

In yet another embodiment, during the process 5106, according to the network address parameters, the network data is captured though calling network data capturing function of the data carrier object. In some embodiments, the network data capturing function can have a polymorphic form. For example, the network data capturing function includes a network data capturing function with capturing parameters of GET or POST (e.g., method types requested in a HTTP protocol) or includes retuned network data in an xml format or a json format. As an example, the corresponding network data capturing function can be called to capture the data according to the network address parameters. After the network data capturing function captures the data, the data can be encapsulated into the xml format or the json format, according to certain embodiments.

In yet another embodiment, during the process S108, the captured network data is analyzed according to the data carrier object and value assignment is carried out on the data carrier object according to the data obtained by analysis. For example, the process for analyzing the captured network data according to the data carrier type identification includes: acquiring a data carrier type identification corresponding to the data carrier object, and according to the data carrier type identification, calling a corresponding analytic function to analyze the captured network data. As an example, after the network data is captured according to the network data capturing function, a corresponding callback function can be called (e.g., calling of the callback function being executed after the network data capturing function returns a capturing result). As another example, the callback function can analyze the captured network data according to the data carrier type identification. As yet another example, if one data carrier object includes the user VO, the data carrier type identification corresponds to “user.” As yet another example, the analytic function corresponding to the “user” can be acquired, or a conditional branch with the data carrier type identification “user” in the analytic function can be executed. The data corresponding to the class attributes of the user VO is analyzed out from the captured network data, according to certain embodiments.

In yet another embodiment, during the process S110, the data carrier object is returned to the control layer object corresponding to the data extraction request. For example, after the process for performing value assignment on the data carrier object according to the data obtained by analysis, storage also can be carried out according to the data carrier object subjected to value assignment. As an example, if the model layer uses the database storage mode as the persistent storage mode, values of the class attributes of the data carrier object are acquired and then are added into the corresponding fields in a data table in the database. As another example, the control layer object can extract the values of the class attributes of the data carrier object and send the values of the class attributes to the view layer object for display. As yet another example, if the view layer is based on a web interface, a name attribute value of the user VO is correspondingly displayed in the user name field. An age attribute value of the user VO is correspondingly displayed in the age field, in certain embodiments.

In yet another embodiment, one or more data carrier objects are inherited from an identical data carrier interface class. For example, the process for calling the network data capturing function of the data carrier object according to the network address parameters to capture the network data by includes: acquiring the network data capturing function defined by the data carrier interface class, transferring the network address parameters as the function parameters to the network data capturing function and acquiring the returned network data corresponding to the network address parameters.

According to certain embodiments, there are various types of data carrier objects corresponding to the data extraction requests. For example, the data extraction requests initiated by different control layer objects can correspond to different data carrier objects. As an example, the various types of data carrier objects can be inherited from the same abstract class. As another example, the various types of data carrier objects implement the same interface (e.g., inherited from the same interface class). As another example, the network data capturing function can be predefined in the interface class. That is, an interface function of the interface class can include the network data capturing function. When a developer adds data carrier object types according to service requirements, a class of the data carrier object which is also inherited from the interface class can be newly built, according to certain embodiments. For example, the data carrier object has the network data capturing function without being repeatedly encoded, so that the scalability of the related codes and the development efficiency are improved.

According to some embodiments, the process for analyzing the captured network data according to the data carrier type identification includes: acquiring a data analysis object corresponding to the data carrier object and calling an interface function of the data analysis object to analyze the captured network data, where the data analysis object is inherited from the same data analysis interface class. For example, the data analysis object can be used as an attribute value of the data carrier object. In another example, different data analysis objects have different analysis logics and correspond to the data carrier objects to which the data analysis objects belong. As an example, the data analysis object of the user VO corresponds to a userParser object, and the data analysis object of the microblog VO corresponds to a weiboParser object. The userParser object and the weiboParser object are inherited from the same data analysis interface class AbstractParser. An interface function “parse” is defined in the AbstractParser. The userParser object and the weieboarser object have different implementing modes for the interface function “parse,” which respectively are an analysis logic corresponding to the user VO and an analysis logic corresponding to the microblog VO, in some embodiments.

According to certain embodiments, after a developer defines a new data carrier object type, the interface function (e.g., the “parse” function) of the data analysis interface class can be implemented by inheriting the data analysis interface class (e.g., the AbstractParser class) according to the analysis logic corresponding to the newly defined data carrier object type, so as to define the data analysis object corresponding to the data carrier object type. For example, the callback function capable of defining the network data capturing function in the data carrier interface class corresponds to the interface function of the data analysis interface class. That is, the data carrier interface class can correspond to the data analysis interface class. In another example, according to a dynamic binding principle designed for objects, the callback function of the network data capturing function of the data carrier object, during execution, corresponds to the interface function of the data analysis object that calls the data carrier object. In yet another example, according to an open/close principle, when adding the new data carrier object type, the developer only needs to add certain codes for analysis without modifying any other code, so that the scalability is improved.

According to some embodiments, if a data carrier object (e.g., an email VO) corresponding to an email needs to be added, the email VO can be defined by inheriting the data carrier interface class. For example, the data analysis object corresponding to the email VO is set to a newly defined email analysis object, and the email analysis object is also inherited from the AbstractParser class. As an example, the developer implements an interface function “parse” of the email analysis object according to an analysis logic of an email service. As another example, during execution, the data extraction request initiated by the control layer object related to the email service corresponds to the email VO. As yet another example, after the network data capturing function of the email VO is called, the interface function “parse” of the email analysis object is called. The interface function “parse” of the email analysis object analyzes the captured data according to the analysis logic defined by the developer and carries out value assignment on the data for the email VO, in some embodiments. The developer only needs to add corresponding analysis without modifying the codes determined according to the data carrier type identification, so that the system scalability is improved, according to certain embodiments.

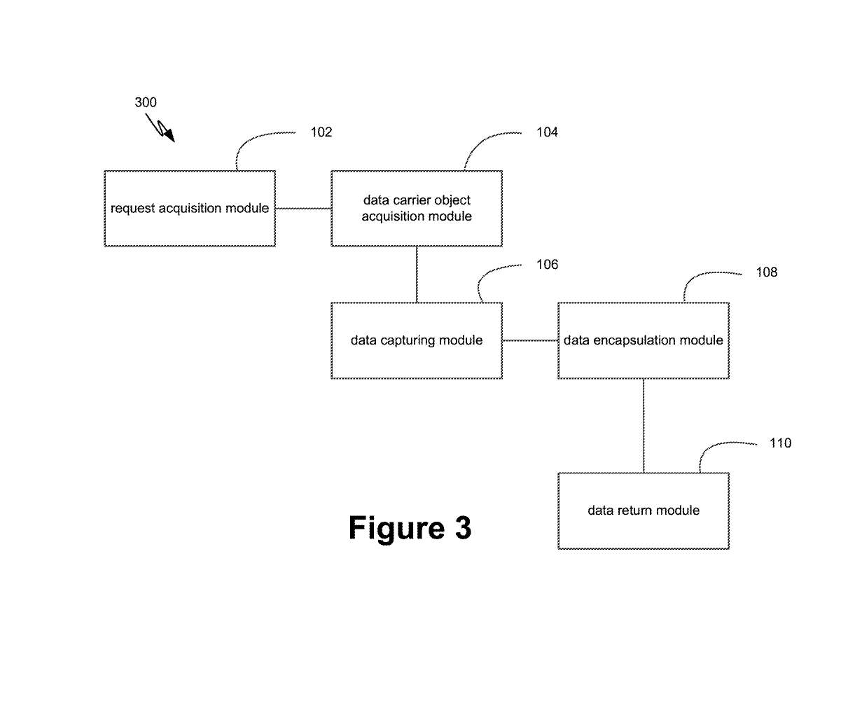

FIG. 3 is a simplified diagram showing a data extraction device based on model-view-controller (MVC) according to one embodiment of the present invention. The diagram is merely an example, which should not unduly limit the scope of the claims. One of ordinary skill in the art would recognize many variations, alternatives, and modifications. The device 300 includes a request acquisition module 102, a data carrier object acquisition module 104, a data capturing module 106, a data encapsulation module 108, and a data return module 110.

According to one embodiment, the request acquisition module 102 is configured to acquire the data extraction request of the control layer object. For example, the data carrier object acquisition module 104 is configured to acquire the network address parameters and the data carrier object corresponding to the data extraction request. As an example, the data capturing module 106 is configured to capture the network data by calling the network data capturing function of the data carrier object according to the network address parameters. As another example, the data encapsulation module 108 is configured to analyze the captured network data according to the data carrier object, and carry out value assignment on the data carrier object according to the data obtained by analysis. As yet another example, the data return module 110 is configured to return the data carrier object to the control layer object corresponding to the data extraction request.

According to another embodiment, the data encapsulation module 108 is further configured to acquire a data carrier type identification corresponding to the data carrier object, and call a corresponding analytic function to analyze the captured network data according to the data carrier type identification. For example, each data carrier object is inherited from a same data carrier interface class. In another example, the data capturing module 106 is further configured to acquire the network data capturing function defined by the data carrier interface class, transfer the network address parameters as the function parameters to the network data capturing function, and acquire the returned network data corresponding to the network address parameters. In yet another example, the data encapsulation module 108 is further configured to acquire the data analysis object corresponding to the data carrier object and call the interface function of the data analysis object to analyze the captured network data, where the data analysis object is inherited from the same data analysis interface class.

According to yet another embodiment, the data carrier object acquisition module 104 is further configured to acquire the persistent data corresponding to the data extraction request, generate the data carrier object corresponding to the data extraction request according to the persistent data, and return the data carrier object when the network address parameters are not acquired.

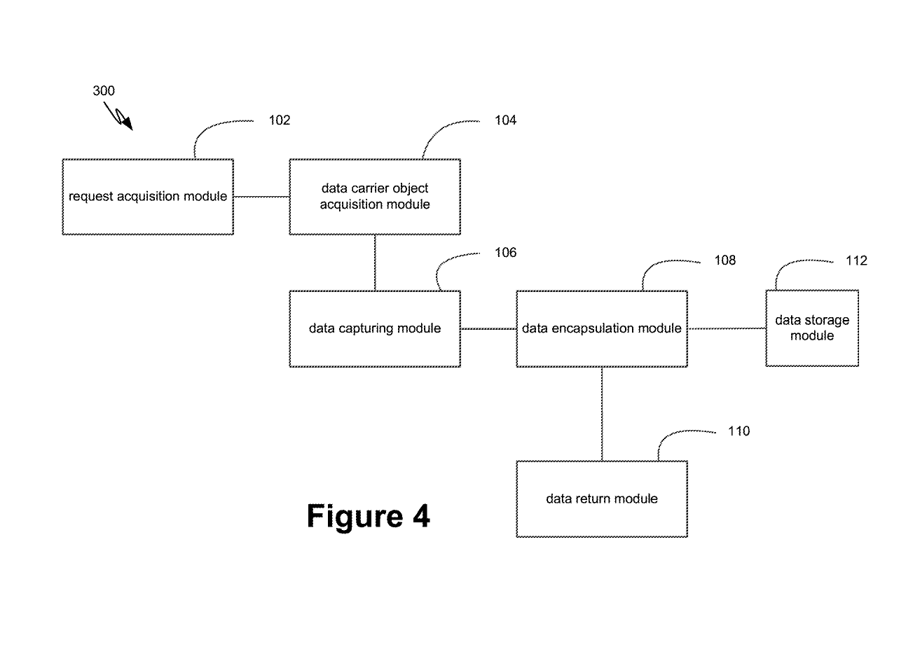

FIG. 4 is a simplified diagram showing a data extraction device based on model-view-controller (MVC) according to another embodiment of the present invention. The diagram is merely an example, which should not unduly limit the scope of the claims. One of ordinary skill in the art would recognize many variations, alternatives, and modifications.

According to one embodiment, the device 300 further includes a data storage module 112 configured to carry out data storage according to the data carrier object that is subjected to value assignment. According to some embodiments, the network data is captured by the data carrier object belonging to the model layer. For example, the captured network data is set into the class attributes of the data carrier object after being analyzed by a callback function. In another example, the class attributes of the data carrier object are returned. As an example, the operation of capturing the network data of the data carrier object is transparent to the control layer object. As another example, the class attribute values of the data carrier object are obtained either through network data capturing or from stored data on the model layer, which does not affect the implementation of the control layer object, so that the degree of coupling between the control layer object and the model layer object is reduced and the scalability is improved.

According to another embodiment, a method is provided for data extraction based on model-view-controller (MVC). For example, a data extraction request of a control layer object is acquired; network address parameters and a data carrier object corresponding to the data extraction request are acquired; a network data capturing function of the data carrier object is called based on at least information associated with the network address parameters to capture network data; the captured network data is analyzed based on at least information associated with the data carrier object; value assignment is performed on the data carrier object based on at least information associated with the analysis of the network data; and the data carrier object is returned to the control layer object corresponding to the data extraction request. For example, the method is implemented according to at least FIG. 2.

According to another embodiment, a device is provided for data extraction based on model-view-controller (MVC). The device includes a request acquisition module configured to acquire a data extraction request of a control layer object; a data carrier object acquisition module configured to acquire network address parameters and a data carrier object corresponding to the data extraction request; a data capturing module configured to call a network data capturing function of the data carrier object based on at least information associated with the network address parameters to capture the network data; a data encapsulation module configured to analyze the captured network data based on at least information associated with the data carrier object and carry out value assignment on the data carrier object based on at least information associated with the data obtained by analysis; and a data return module configured to return the data carrier object to the control layer object corresponding to the data extraction request. For example, the device is implemented according to at least FIG. 3 and/or FIG. 4.

According to yet another embodiment, a non-transitory computer readable storage medium includes programming instructions for data extraction based on model-view-controller (MVC). The programming instructions are configured to cause one or more data processors to execute certain operations. For example, a data extraction request of a control layer object is acquired; network address parameters and a data carrier object corresponding to the data extraction request are acquired; a network data capturing function of the data carrier object is called based on at least information associated with the network address parameters to capture network data; the captured network data is analyzed based on at least information associated with the data carrier object; value assignment is performed on the data carrier object based on at least information associated with the analysis of the network data; and the data carrier object is returned to the control layer object corresponding to the data extraction request. For example, the storage medium is implemented according to at least FIG. 2.

The above only describes several scenarios presented by this invention, and the description is relatively specific and detailed, yet it cannot therefore be understood as limiting the scope of this invention. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

1. A data extraction method based on model-view-controller (MVC), comprising:
acquiring a data extraction request of a control layer object;
acquiring network address parameters and a data carrier object corresponding to the data extraction request;
calling a network data capturing function of the data carrier object based on at least information associated with the network address parameters to capture network data;
analyzing the captured network data based on at least information associated with the data carrier object;
performing value assignment on the data carrier object based on at least information associated with the analysis of the network data; and
returning the data carrier object to the control layer object corresponding to the data extraction request.

2. The method of claim 1, wherein the analyzing the captured network data based on at least information associated with the data carrier object includes:
acquiring a data carrier type identification corresponding to the data carrier object; and
calling a corresponding analytic function to analyze the captured network data based on at least information associated with the data carrier type identification.

3. The method of claim 1, wherein:
the data carrier object is inherited from a data carrier interface class; and
the calling a network data capturing function of the data carrier object based on at least information associated with the network address parameters to capture network data includes:
acquiring the network data capturing function defined by the data carrier interface class;
transferring the network address parameters as function parameters to the network data capturing function; and
acquiring the network data corresponding to the network address parameters.

4. The method of claim 1, wherein the analyzing the captured network data based on at least information associated with the data carrier object includes:
acquiring a data analysis object corresponding to the data carrier object, wherein the data analysis object is inherited from the data analysis interface class; and
calling an interface function of the data analysis object to carry out analysis based on at least information associated with the captured network data.

5. The method of claim 1, further comprising:
in response to the network address parameters not being acquired,
acquiring persistent data corresponding to the data extraction request;
generating the data carrier object corresponding to the data extraction request based on at least information associated with the persistent data; and
returning the data carrier object.

6. The method of claim 1, further comprising:
performing data storage based on at least information associated with the data carrier object after the value assignment.

7. A data extraction device based on model-view-controller (MVC), comprising:
a request acquisition module configured to acquire a data extraction request of a control layer object;
a data carrier object acquisition module configured to acquire network address parameters and a data carrier object corresponding to the data extraction request;
a data capturing module configured to call a network data capturing function of the data carrier object based on at least information associated with the network address parameters to capture the network data;
a data encapsulation module configured to analyze the captured network data based on at least information associated with the data carrier object and carry out value assignment on the data carrier object based on at least information associated with the data obtained by analysis; and
a data return module configured to return the data carrier object to the control layer object corresponding to the data extraction request.

8. The device of claim 7, wherein the data encapsulation module is further configured to acquire a data carrier type identification corresponding to the data carrier object, and call an analytic function to analyze the captured network data based on at least information associated with the data carrier type identification.

9. The device of claim 7, wherein:
the data carrier object is inherited from a data carrier interface class; and
the data capturing module is further configured to acquire the network data capturing function defined by the data carrier interface class, transfer the network address parameters as the function parameters to the network data capturing function, and acquire the network data corresponding to the network address parameters.

10. The device of claim 7, wherein:
the data encapsulation module is further configured to acquire the data analysis object corresponding to the data carrier object;
the data analysis object is inherited from the same data analysis interface class; and
the interface function of the data analysis object is called for analyzing the captured network data.

11. The device of claim 7, wherein the data carrier object acquisition module is further configured to, in response to the network address parameters not being acquired, acquire persistent data corresponding to the data extraction request, generate the data carrier object corresponding to the data extraction request based on at least information associated with the persistent data, and return the data carrier object.

12. The device of claim 7, further comprising:
a data storage module configured to carry out data storage based on at least information associated with the data carrier object after the value assignment.

13. The device of claim 7, further comprising:
one or more data processors; and
a computer-readable storage medium;
wherein one or more of the request acquisition module, the data carrier object acquisition module, the data capturing module, the data encapsulation module, and the data return module are stored in the storage medium and configured to be executed by the one or more data processors.

14. A non-transitory computer readable storage medium comprising programming instructions for data extraction based on model-view-controller (MVC), the programming instructions configured to cause one or more data processors to execute operations comprising:
acquiring a data extraction request of a control layer object;
acquiring network address parameters and a data carrier object corresponding to the data extraction request;
calling a network data capturing function of the data carrier object based on at least information associated with the network address parameters to capture network data;
analyzing the captured network data based on at least information associated with the data carrier object;
performing value assignment on the data carrier object based on at least information associated with the analysis of the network data; and
returning the data carrier object to the control layer object corresponding to the data extraction request.
